(19) United States
(12) Patent Application Publication
(10) Pub. No.: US 2021/0380741 A1
(43) Pub. Date: Dec. 9, 2021

(54) DISPERSIBLE IONOMER POWDER AND METHOD OF MAKING THE SAME

(71) Applicant: SOLVAY SPECIALTY POLYMERS ITALY S.P.A., Bollate (IT)

(72) Inventors: Luca MERLO, Ixelles (BE); Claudio OLDANI, Parabiago (IT)

(21) Appl. No.: 17/284,010

(22) PCT Filed: Nov. 4, 2019
(86) PCT No.: PCT/EP2019/080087

§ 371 Date: Apr. 9, 2021

(30) Foreign Application Priority Data
Nov. 5, 2018 (EP) 18204459.4

(51) Int. Cl. C08F 216/14; C09D 129/10

(52) U.S. Cl. CPC C08F 216/1475; C08F 2810/00; C08F 2800/20; C09D 129/10

(57) ABSTRACT

The present invention relates to certain dispersible ionomer powders made of particles consisting in quasi-spherical hollow agglomerates of elementary particles, to a method for their manufacture involving spray-drying of a latex of said ionomer, and to methods of using the same, notably for coating applications.

### CROSS-REFERENCE TO RELATED APPLICATION

This application claims priority to European Application number 18204459.4 filed on 5 Nov. 2018, the whole content of this application being incorporated herein by reference for all purposes.

### TECHNICAL FIELD

The present invention relates to certain dispersible ionomer powders, to a method for their manufacture, and to methods of using the same, notably for coating applications.

### BACKGROUND ART

Fluorinated ionomers possessing carboxylic or sulfonic acid groups, and more specifically, perfluorosulfonic acid (PFSA) polymers are semicrystalline materials which are known to be quite difficult to dissolve/disperse in solvents unless using harsh conditions (i.e. 250° C. under pressure in water).

Actually, as-polymerized materials are typically provided under the form of latexes of polymer precursors, which need undergoing hydrolysis for achieving ion exchange ability. Once coagulated and hydrolysed, the acid-form materials could be re-dispersed in water, possibly in admixture with low amount of alcohol solvents, solely by extensive heat treatment, providing for dispersed particles in the said aqueous phase.

Now, end-users may need to formulate the said acid-form materials as coating compositions based on solvents other than water, e.g. for impregnating a variety of supports, so that availability of easily dispersible powders of said fluorinated ionomers would be highly beneficial in the market space.

In this area, hence, document US2008/0227875 discloses solid and liquid compositions containing particles of highly fluorinated ion-exchange polymer having sulfonate functional groups. Liquid aqueous composition is produced by dispersing said polymer in an aqueous medium under severe conditions of high temperature and high stirring. Solid compositions can be produced from said liquid compositions by removing liquid components of the aqueous liquid composition, by evaporation at a temperature less than the coalescence temperature of the ion exchanged polymer in the composition. By “coalescence temperature” is meant the temperature at which a dried solid of the polymer is cured to a stable solid which is not re-dispersible in water or other polar solvents under mild conditions, i.e., room temperature/atmospheric pressure. This document teaches that coalescence temperatures vary with polymer composition, whereas preferred conditions are those wherein liquid components are removed by heating to a temperature of less than about 100° C. Among techniques for effecting this removal, mention is made of freeze-drying and spray drying at a temperature less that the coalescence temperature. The result of this method is a re-dispersible powdered composition of fluoroionomer.

Similarly, document US 2008/0160351 is directed to a method of making a dispersion of highly fluorinated ion exchange polymer, including a step of atomizing in a heated gas a dispersion in an organic liquid of said polymer, and re-dispersing the particles so-obtained in a second liquid. In the examples, fluoroionomer dispersions were first prepared in a liquid medium comprising an amount of about 20-25% alcohol (NPA) in water under relatively harsh conditions; the alcohol/water dispersion was then spray-dried in a nitrogen flow gas kept at a temperature of 170 to 210° C., giving rise to particles having residual moisture of around 4-5% wt., particle size of about 25-40 μm and bulk densities of 30 to 50 g/l. So obtained powders were easily re-dispersed in liquid media of different composition at room temperature.

Still document CN103044698B is directed to a method for making a membrane, wherein a perfluorinated sulfonic acid resin is dissolved in a low boiling point solvent to obtain a solution with low solid content of 3-15 wt. %; in a second step, filtering solution and spray-drying are effected to provide for perfluorinated sulfonic acid resin powder; and in a subsequent step, the powder so obtained is re-dissolved in high boiling point solvent to prepare solution with high solid content of 25-50 wt. %; and removing bubbles on the solution and coating the solution on solid surface to form film, drying and rolling to obtain the perfluorosulfonic acid ion exchange membrane.

Further, document US2011/0240559 describes a method for purifying a liquid PFSA dispersion, by contacting with a solid particulate of PFSA having SO₃H groups; this solid particulate PFSA having acid groups is obtained from a perfluorosulfonic acid precursor, prepared by emulsion polymerization, and possessing sulfonyl fluoride groups, and further submitted to coagulation, hydrolysis, and drying. This document does not describe hydrolysis of PFSA precursor in latex form, nor describe spray-drying technique.

Now, while the problem of providing re-dispersible fluorinated ionomer powders has been already tackled in the prior art, handling of resulting dispersions for formulating coating compositions remain a challenge, as the achievable concentration remain low, and corresponding viscosity in the liquid state is quite often too low for being compatible with standard coating liquid formulation techniques, so that viscosities of resulting formulations have to be corrected by addition of viscosity modifiers and/or thickening agents, which may thereafter remain entrapped in the final coated/impregnated article.

There is hence still a need in the art for methods for providing dispersible fluoroionomer powders, and fluoroionomer powders therefrom, which could address unmet needs of the market, including delivery high solids, high viscous formulations in a variety of solvents through an easy manufacturing methodology.

### SUMMARY OF INVENTION

In facing this technical problem, the Applicant has found a method for making a ionomer powder, which is particularly advantageous in that it avoids the use of harsh conditions, and which delivers particles possessing particularly advantageous properties, in particular in terms of achievable liquid viscosities of formulations therefrom.

Thus, in a first aspect, the present invention relates to a method for making a powdery material [material (P)] composed of a plurality of particles of at least one ionisable polymer comprising a plurality of ionisable groups selected from the group consisting of —SO₃Xₐ, —PO₃Xₐ and —COOXₐ, whereas Xₐ is H, an ammonium group or a metal, preferably a monovalent metal [ionomer (I_{X})], said method comprising:

Step (1): providing an as-polymerized aqueous latex [latex (Iₚ)] comprising particles of at least one ionomer precursor comprising a plurality of hydrolysable groups selected from the group consisting of —SO₂X_{X}, —PO₂X_{X} and —COX_{X}, whereas X_{X} is a halogen, in particular F or Cl [precursor (Iₚ)]; and

Step (2): contacting said as-polymerized aqueous latex [latex (I_{X})] with a basic hydrolysing agent [agent (B)], in conditions such as to at least partially convert said groups —SO₂X_{X}, —PO₂X_{X} and —COX_{X}, whereas X_{X} is F or Cl, into corresponding groups —SO₃Xₐ, —PO₃Xₐ and —COOXₐ, whereas Xₐ is H, an ammonium group or a monovalent metal, without causing any significant coagulation, so as to obtain an aqueous latex of particles of ionomer (I_{X});

optionally, Step (3): contacting said latex (Iₓ) with at least one ion exchange resin, so as to at least partially remove residues of agent (B) and/or other contaminants; and

Step (4): spray drying the latex (Iₓ), possibly after purification, so as to obtain the said material (P).

In a second aspect, the present invention relates to a powdery material [material (P)] which can be obtained by the method as above detailed, said powdery material being composed of a plurality of particles of at least one fluorinated ionomer comprising a plurality of ionisable groups selected from the group consisting of —SO₃Xₐ, —PO₃Xₐ and —COOXₐ, whereas Xₐ is H, an ammonium group or a metal, preferably a monovalent metal [ionomer (I_{X})],

said particles consisting in quasi-spherical hollow agglomerates of elementary particles,
said hollow agglomerate possessing an average particle size of 1 to 150 μm; and
said elementary particles possessing an average diameter of 15 to 150 nm.

In particular, the Applicant has found that the method of the present invention, which does not involve any step of coagulation and then re-dissolution of the precursor/ionomer is particularly effective from economic perspective and uses milder conditions for processing the precursor to a powdery material, hence being per se very advantageous. Further, the method as detailed above provides for a powdery material possessing a particularly advantageous particles microstructure, which renders the said powdery material to easily re-dissolve and to provide increased liquid viscosities, so as to render formulations therefrom able to match viscosity requirements for a large number of coating/liquid processing techniques, without the need of addition spurious viscosity enhancers and/or thickening agents.

The Ionisable Polymer [Ionomer (I_{X})] and the Ionomer Precursor [Precursor (I_{P})]

The ionisable polymer, otherwise referred to as ionomer (I_{X}) of the present invention, as well as its precursor (Iₚ), is generally fluorinated, that is to say comprises recurring units derived from ethylenically unsaturated monomer comprising at least one fluorine atom, and may further comprise recurring units derived from at least one hydrogenated monomer, wherein the term “hydrogenated monomer” is intended to denote an ethylenically unsaturated monomer comprising at least one hydrogen atom and free from fluorine atoms.

As said, ionomer (I_{X}) comprises a plurality of ionisable groups selected from the group consisting of —SO₃Xₐ, —PO₃Xₐ and —COOXₐ, whereas Xₐ is H, an ammonium group or a metal, preferably a monovalent metal, while precursor (Iₚ) comprises a plurality of hydrolysable groups selected from the group consisting of —SO₂X_{X}, —PO₂X_{X} and —COX_{X}, whereas X_{X} is a halogen, in particular F or Cl [precursor (Iₚ)].

As examples of preferred monovalent metals suitable as counter-ion Xₐ in ionisable groups of ionomer (I_{X}) mention can be notably made of Li, K, Na, whereas Li may be preferred for certain fields of use of ionomer (lx), e.g. in connection with the use of the same in the domain of secondary batteries and other electrochemical devices based on Li⁺/Li redox couple.

Generally, ionomer (lx) comprises said ionisable groups as pendant groups covalently bound to hydrolysed recurring units derived from a functional monomer (monomer (X), herein below). Similarly, generally, precursor (Iₚ) comprises said hydrolysable groups as pendant groups covalently bound to recurring units derived from said functional monomer (monomer (X), herein below).

The expression ‘hydrolyzed recurring units derived from’ in connection with a particular monomer is intended to designate recurring units which are first derived/directly obtained from polymerizing the said particular monomer, and then derived/obtained by further modification/finishing of the same by hydrolysis.

Ionomer (I_{X}) may consist essentially of a sequence of hydrolysed recurring units derived from one or more than one monomer (X), as above detailed, or can be a copolymer comprising hydrolysed recurring units derived from one or more than one monomer (X) and recurring units derived from one or more than one additional monomer different from monomer (X). Similarly, precursor (I_{P}), from which ionomer (I_{X}) is obtained, may consist essentially of a sequence of recurring units derived from one or more than one monomer (X), as above detailed, or can be a copolymer comprising recurring units derived from one or more than one monomer (X) and recurring units derived from one or more than one additional monomer different from monomer (X).

Generally, monomer (X) is a fluorinated monomer; further one or more than one additional monomer different from monomer (X) may be a fluorinated monomer. The expression ‘fluorinated monomer’ is intended to encompass ethylenically unsaturated monomers comprising at least one fluorine atom.

According to certain embodiment's of the invention, ionomer (I_{X}) comprises a plurality of —SO₃Xₐ group, as above detailed, that is to say is an ionomer (I_{SO3X}). According to these embodiment's, precursor (I_{P}) comprises a plurality of groups —SO₂X_{X}, as above detailed, that is to say is a precursor (P_{SO2X}).

Ionomer (I_{SO3X}) may consist essentially of a sequence of a plurality of recurring units derived from one or more than one monomer (X_{SO3X}) comprising at least one group of formula —SO₃Xₐ, as above detailed, or can comprise a plurality of recurring units derived from one or more than one monomer (X_{SO3X}) and recurring units derived from one or more than one additional monomer different from monomer (X_{SO3X}).

Similarly, precursor (P_{SO2X}) may consist essentially of a sequence of a plurality of recurring units derived from one or more than one monomer (X^{P}_{SO2X}) comprising at least one group of formula —SO₂X_{X}, as above detailed, or can comprise a plurality of recurring units derived from one or more than one monomer (X^{P}_{SO2X}) and recurring units derived from one or more than one additional monomer different from monomer (X^{P}_{SO2X}).

Suitable preferred ionomer (I_{SO3X}) comprising a plurality of —SO₃Xₐ groups are those polymers consisting essentially of a plurality of hydrolysed recurring units comprising at least one —SO₃Xₐ group, with Xₐ being H, an ammonium group or a metal, preferably a monovalent metal, and derived from at least one ethylenically unsaturated fluorinated monomer containing at least one —SO₂X_{X} group, with Xₓ being a halogen [monomer (A), hereinafter]; and a plurality of recurring units deriving from at least one ethylenically unsaturated fluorinated monomer free from —SO₂X_{X} group, as above detailed [monomer (B), hereinafter]. Corresponding precursors (P_{SO2X}) are those polymers consisting essentially of a plurality of recurring units comprising at least one —SO₂X_{X} group and deriving from at least one ethylenically unsaturated fluorinated monomer containing at least one monomer (A), as detailed above; and a plurality of recurring units deriving from at least one monomer (B), as detailed above.

As already said, the expression ‘hydrolyzed recurring units derived from’ in connection with a particular monomer (A) is intended to designate recurring units which are first derived/directly obtained from polymerizing the said particular monomer, and then derived/obtained by further modification/finishing of the same, by hydrolysis, transforming the said at least one —SO₂X_{X} group, with X_{X} being a halogen, into said at least one —SO₃Xₐ group, with Xₐ is H, an ammonium group or a metal, preferably a monovalent metal.

The phrase “at least one monomer” is used herein with reference to monomers of both type (A) and (B) to indicate that one or more than one monomer of each type can be present in the ionomer (I_{SO3X}) and/or precursor (P_{SO2X}). Hereinafter the term monomer will be used to refer to both one and more than one monomer of a given type.

Non limiting examples of suitable monomers (A) are:
sulfonyl halide fluoroolefins of formula: CF₂═CF(CF₂)ₚSO₂X_{X}, with X_{X} being a halogen, preferably, F or Cl, more preferably F, wherein p is an integer between 0 and 10, preferably between 1 and 6, more preferably p is equal to 2 or 3;
sulfonyl halide fluorovinylethers of formula: CF₂═CF—O—(CF₂)ₘSO₂X_{X}, with X_{X} being a halogen, preferably, F or Cl, more preferably F, wherein m is an integer between 1 and 10, preferably between 1 and 6, more preferably between 2 and 4, even more preferably m equals 2;
sulfonyl fluoride fluoroalkoxyvinylethers of formula: CF₂═CF—(OCF₂CF(R_{F1}))_{w}—O—CF₂(CF(R_{F2}))_{y}SO₂X_{X}, with X_{X} being a halogen, preferably, F or Cl, more preferably F; wherein w is an integer between 0 and 2, R_{F1} and R_{F2}, equal or different from each other, are independently F, Cl or a C₁-C₁₀ fluoroalkyl group, optionally substituted with one or more ether oxygens, y is an integer between 0 and 6; preferably w is 1, R_{F1} is —CF₃, y is 1 and R_{F2} is F;
sulfonyl halide aromatic fluoroolefins of formula CF₂═CF—Ar—SO₂X_{X}, with X_{X} being a halogen, preferably, F or Cl, more preferably F, wherein Ar is a C₅-C₁₅ aromatic or heteroaromatic group.

Preferably monomer (A) is selected from the group of the sulfonyl fluoride fluorovinylethers of formula CF₂═CF—O—(CF₂)ₘ—SO₂F, wherein m is an integer between 1 and 6, preferably between 2 and 4.

More preferably monomer (A) is CF₂═CFOCF₂CF₂—SO₂F (perfluoro-5-sulfonylfluoride-3-oxa-1-pentene).

Non limiting examples of suitable ethylenically unsaturated fluorinated monomers of type (B) are:
C₂-C₈ perfluoroolefins, such as tetrafluoroethylene (TFE), hexafluoropropylene (HFP), perfluoroisobutylene;
C₂-C₈ hydrogen-containing fluoroolefins, such as trifluoroethylene (TrFE), vinylidene fluoride (VDF), vinyl fluoride (VF), pentafluoropropylene, and hexafluoroisobutylene;
C₂-C₈ chloro- and/or bromo- and/or iodo-containing fluoroolefins, such as chlorotrifluoroethylene (CTFE) and bromotrifluoroethylene;
fluoroalkylvinylethers of formula CF₂═CFOR_{f1}, wherein R_{f1} is a C₁-C₆ fluoroalkyl, e.g. —CF₃, —C₂F₅, —C₃F₇;
fluorooxyalkylvinylethers of formula CF₂═CFOX₀, wherein X₀ is a C₁-C₁₂ fluorooxyalkyl group comprising one or more than one ethereal oxygen atom, including notably fluoromethoxyalkylvinylethers of formula CF₂═CFOCF₂OR_{f2}, with R_{f2} being a C₁-C₃ fluoro(oxy)alkyl group, such as —CF₂CF₃, —CF₂CF₂—O—CF₃ and —CF₃
fluorodioxoles, of formula:

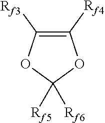

wherein each of R_{f3}, R_{f4}, R_{f5}, R_{f6}, equal or different each other, is independently a fluorine atom, a C₁-C₆ fluoro(halo)fluoroalkyl, optionally comprising one or more oxygen atom, e.g. —CF₃, —C₂F₅, —C₃F₇, —OCF₃, —OCF₂CF₂OCF₃.

Preferably monomer (B) is selected among:
C₂-C₈ perfluoroolefins selected from tetrafluoroethylene (TFE) and/or hexafluoropropylene (HFP);
C₂-C₈ hydrogen-containing fluoroolefins, selected from trifluoroethylene (TrFE), vinylidene fluoride (VDF), and vinyl fluoride (VF); and
mixtures thereof.

According to these embodiment's, preferably, ionomer (I_{SO3X}) comprises a plurality of —SO₃Xₐ functional groups, and essentially consists in a sequence of a plurality of hydrolysed recurring units derived from at least one ethylenically unsaturated fluorinated monomer (A) containing at least one sulfonyl fluoride functional group (group —SO₂F) and a plurality of recurring units derived from at least one ethylenically unsaturated fluorinated monomer (B). In these embodiment's, precursors (P_{SO2X}) essentially consists in a sequence of a plurality of recurring units derived from at least one ethylenically unsaturated fluorinated monomer (A) containing at least one sulfonyl fluoride functional group (group —SO₂F) and a plurality of recurring units derived from at least one ethylenically unsaturated fluorinated monomer (B).

End-groups, impurities, defects and other spurious units in limited amount (less than 1% moles, with respect to total moles of recurring units) may be present in the preferred ionomer (I_{SO3X}) and/or in preferred precursors (P_{SO2X}), in addition to the listed recurring units, without this affecting substantially the properties of the ionomer (I_{SO3X}) or the precursor (P_{SO2X}), as the case may be.

According to certain embodiments, at least one monomer (B) of the ionomer (I_{SO3X}) or of the corresponding precursor (P_{SO2X}) is TFE. Ionomers (I_{SO3X}) wherein said at least one monomer (B) is TFE will be hereby referred to as ionomers (I^{TFE}_{SO3X}), whereas corresponding precursors (P_{SO2X}) will be referred to as precursors (P^{TFE}_{SO2X}).

Preferred ionomers (I^{TFE}_{SO3X}) are selected from polymers consisting essentially of:
(1) recurring units derived from tetrafluoroethylene (TFE), these recurring units (1) being generally in an amount of 50 to 99% moles, preferably 52 to 98% moles, with respect to total moles of recurring units of ionomers (I^{TFE}_{SO3X});
(2) hydrolysed recurring units comprising at least one —SO₃Xₐ group and derived from at least one monomer selected from the group consisting of:
(j) sulfonyl halide fluorovinylethers of formula: CF₂═CF—O—(CF₂)ₘSO₂X_{X}, with X_{X} being a halogen, preferably, F or Cl, more preferably F; wherein m is an integer between 1 and 10, preferably between 1 and 6, more preferably between 2 and 4, even more preferably m equals 2;
(jj) sulfonyl fluoride fluoroalkoxyvinylethers of formula: CF₂═CF—(OCF₂CF(R_{F1}))_{w}—O—CF₂(CF(R_{F2}))_{y}SO₂X_{X}, with X_{X} being a halogen, preferably, F or Cl, more preferably F; wherein w is an integer between 0 and 2, R_{F1} and R_{F2}, equal or different from each other, are independently F, Cl or a C₁-C₁₀ fluoroalkyl group, optionally substituted with one or more ether oxygens, y is an integer between 0 and 6; preferably w is 1, R_{F1} is —CF₃, y is 1 and R_{F2} is F; and
(jjj) mixtures thereof;
these recurring units (2) being generally in an amount of 1 to 50% moles, preferably 2 to 48% moles, with respect to total moles of recurring units of ionomers (I^{TFE}_{SO3X}); and
(3) optionally, recurring units derived from at least one hydrogenated and/or fluorinated monomer different from TFE, preferably a perfluorinated monomer, generally selected from the group consisting of hexafluoropropylene, perfluoroalkylvinylethers of formula CF₂═CFOR′_{f1}, wherein R′_{f1} is a C₁-C₆ perfluoroalkyl, e.g. —CF₃, —C₂F₅, —C₃F₇; perfluoro-oxyalkylvinylethers of formula CF₂═CFOR′_{O1}, wherein R′_{O1} is a C₂-C₁₂ perfluoro-oxyalkyl having one or more ether groups, including e.g. perfluoroalkyl-methoxy-vinylethers of formula CF₂═CFOCF₂OR′_{f2} in which R′_{f2} is a C₁-C₆ perfluoroalkyl, e.g. —CF₃, —C₂F₅, —C₃F₇ or a C₁-C₆ perfluorooxyalkyl having one or more ether groups, like —C₂F₅—O—CF₃; these recurring units (3) being generally in an amount of 0 to 45% moles, preferably 0 to 40% moles, with respect to total moles of recurring units of ionomers (I^{TFE}_{SO3X}).

Consistently, preferred precursors (P^{TFE}_{SO2X}), from which the said preferred ionomers (I^{TFE}_{SO3X}) may be obtained are selected from polymers consisting essentially of:

(1) recurring units derived from tetrafluoroethylene (TFE), these recurring units (1) being generally in an amount of 50 to 99% moles, preferably 52 to 98% moles, with respect to total moles of recurring units of precursors (P^{TFE}_{SO2X})

(2) recurring units derived from at least one monomer selected from the group consisting of:

(j) sulfonyl halide fluorovinylethers of formula: CF₂═CF—O—(CF₂)ₘSO₂X_{X}, with X_{X} being a halogen, preferably, F or Cl, more preferably F; wherein m is an integer between 1 and 10, preferably between 1 and 6, more preferably between 2 and 4, even more preferably m equals 2;

(jj) sulfonyl fluoride fluoroalkoxyvinylethers of formula: CF₂═CF—(OCF₂CF(R_{F1}))_{w}—O—CF₂(CF(R_{F2}))X_{X}, with X_{X} being a halogen, preferably, F or Cl, more preferably F; wherein w is an integer between 0 and 2, R_{F1} and R_{F2}, equal or different from each other, are independently F, Cl or a C₁-C₁₀ fluoroalkyl group, optionally substituted with one or more ether oxygens, y is an integer between 0 and 6; preferably w is 1, R_{F1} is —CF₃, y is 1 and R_{F2} is F; and

(jjj) mixtures thereof;

these recurring units (2) being generally in an amount of 1 to 50% moles, preferably 2 to 48% moles, with respect to total moles of recurring units of precursors (P^{TFE}_{SO2X}); and

(3) optionally, recurring units derived from at least one hydrogenated and/or fluorinated monomer different from TFE, preferably a perfluorinated monomer, generally selected from the group consisting of hexafluoropropylene, perfluoroalkylvinylethers of formula CF₂═CFOR′_{f1}, wherein R′_{f1} is a C₁-C₆ perfluoroalkyl, e.g. —CF₃, —C₂F₅, —C₃F₇; perfluoro-oxyalkylvinylethers of formula CF₂═CFOR′_{O1}, wherein R′_{O1} is a C₂-C₁₂ perfluoro-oxyalkyl having one or more ether groups, including e.g. perfluoroalkyl-methoxy-vinylethers of formula CF₂═CFOCF₂OR′_{f2} in which R′_{f2} is a C₁-C₆ perfluoroalkyl, e.g. —CF₃, —C₂F₅, —C₃F₇ or a C₁-C₆ perfluorooxyalkyl having one or more ether groups, like —C₂F₅—O—CF₃; these recurring units (3) being generally in an amount of 0 to 45% moles, preferably 0 to 40% moles, with respect to total moles of recurring units of precursors (P^{TFE}_{SO2X}).

According to certain embodiment's, the preferred ionomers (I^{TFE}_{SO3X}) generally consists essentially of:

(k) from 55 to 95% moles, preferably from 65 to 93% moles of recurring units derived from TFE;

(kk) from 5 to 45% moles, preferably from 7 to 35% moles of hydrolysed recurring units comprising at least one —SO₃Xₐ group and derived from monomer(s) (2), as above detailed;

(3) from 0 to 25% moles, preferably from 0 to 20% moles of recurring units derived from fluorinated monomer(s) different from TFE (3), as above detailed, based on the total moles of recurring units of said ionomers (I^{TFE}_{SO3X}).

Same holds true, mutatis mutandis, for preferred precursors (P^{TFE}_{SO2X}), whereas units derived from monomer(s) (2), as above detailed are comprised, instead of their corresponding hydrolysed counterparts.

According to certain other embodiments, at least one monomer (B) of the ionomers (I_{SO3X}) or of the corresponding precursor (P_{SO2X}) is VDF. Ionomers (I_{SO3X}) wherein at least one monomer (B) is VDF will be hereby referred to as ionomers (I^{VDF}_{SO3X}), whereas corresponding precursors (P_{SO2X}) will be referred to as precursors (P^{VDF}_{SO2X})

Preferred ionomers (I^{VDF}_{SO3X}) are selected from polymers consisting essentially of:

(1) recurring units derived from vinylidene fluoride (VDF), these recurring units (1) being generally in an amount of 55 to 99% moles, preferably 70 to 95% moles, with respect to total moles of recurring units of ionomers (I^{VDF}_{SO3X});

(2) hydrolysed recurring units comprising at least one —SO₃Xₐ group and derived from at least one monomer selected from the group consisting of:

(j) sulfonyl halide fluorovinylethers of formula: CF₂═CF—O—(CF₂)ₘSO₂X_{X}, with X_{X} being a halogen, preferably, F or Cl, more preferably F, wherein m is an integer between 1 and 10, preferably between 1 and 6, more preferably between 2 and 4, even more preferably m equals 2;

(jj) sulfonyl fluoride fluoroalkoxyvinylethers of formula: CF₂═CF—(OCF₂CF(R_{F1}))_{w}—O—CF₂(CF(R_{F2}))_{y}SO₂X_{X} with X_{X} being a halogen, preferably, F or Cl, more preferably F, wherein w is an integer between 0 and 2, R_{F1} and R_{F2}, equal or different from each other, are independently F, Cl or a C₁-C₁₀ fluoroalkyl group, optionally substituted with one or more ether oxygens, y is an integer between 0 and 6; preferably w is 1, R_{F1} is —CF₃, y is 1 and R_{F2} is F; and

(jjj) mixtures thereof;

these recurring units (2) being generally in an amount of 1 to 45% moles, preferably 5 to 30% moles, with respect to total moles of recurring units of ionomers (I^{VDF}_{SO3X}); and

(3) optionally, recurring units derived from at least one hydrogenated monomer or fluorinated monomer different from VDF; these recurring units (3) being generally in an amount of 0 to 30% moles, preferably 0 to 15% moles, with respect to total moles of recurring units of ionomers (I^{VDF}_{SO3X}).

According to certain embodiment's, the preferred ionomers (I^{VDF}_{SO3X}) are polymers generally consisting essentially of:

(1) from 55 to 95% moles, preferably from 70 to 92% moles of recurring units derived from VDF;

(2) from 5 to 40% moles, preferably from 8 to 30% moles of hydrolysed recurring units comprising at least one —SO₃Xₐ group and derived from at least one monomer(s) (2), as above detailed;

(3) from 0 to 15% moles, preferably from 0 to 10% moles of recurring units derived from hydrogenated or fluorinated monomer(s) different from VDF (3), as above detailed,

based on the total moles of recurring units of said ionomers (I^{VDF}_{SO3X}).

The ionomers (I_{X}) and/or their precursors (I_{P}) may further comprise recurring units derived from at least one bis-olefin [bis-olefin (OF)] of formula:

R_{A}R_{B}═CR_{C}-T-CR_{D}═R_{E}R_{F}

wherein R_{A}, R_{B}, R_{C}, R_{D}, R_{E} and R_{F}, equal to or different from each other, are selected from the group consisting of H, F, Cl, C₁-C₅ alkyl groups and C₁-C₅ (per)fluoroalkyl groups, and T is a linear or branched C₁-C₁₈ alkylene or cycloalkylene group, optionally comprising one or more than one ethereal oxygen atom, preferably at least partially fluorinated, or a (per)fluoropolyoxyalkylene group.

The bis-olefin (OF) is preferably selected from the group consisting of those of any of formulae (OF-1), (OF-2) and (OF-3):

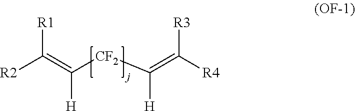

wherein j is an integer comprised between 2 and 10, preferably between 4 and 8, and R1, R2, R3 and R4, equal to or different from each other, are selected from the group consisting of H, F, C₁-C₅ alkyl groups and C₁-C₅ (per)fluoroalkyl groups;

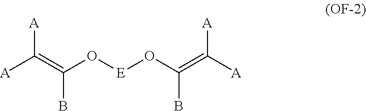

wherein each of A, equal to or different from each other and at each occurrence, is independently selected from the group consisting of H, F and Cl; each of B, equal to or different from each other and at each occurrence, is independently selected from the group consisting of H, F, Cl and ORB, wherein R_{B} is a branched or straight chain alkyl group which may be partially, substantially or completely fluorinated or chlorinated, E is a divalent group having 2 to 10 carbon atoms, optionally fluorinated, which may be inserted with ether linkages; preferably E is a —(CF₂)ₘ— group, wherein m is an integer comprised between 3 and 5; a preferred bis-olefin of (OF-2) type is F₂C═CF—O—(CF₂)₅—O—CF═CF₂;

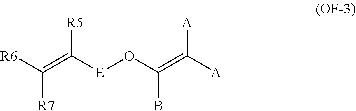

wherein E, A and B have the same meaning as defined above, R5, R6 and R7, equal to or different from each other, are selected from the group consisting of H, F, C₁-C₅ alkyl groups and C₁-C₅ (per)fluoroalkyl groups.

Should the ionomers (I_{X}) or their precursors (I_{P}) further comprise recurring units derived from at least one bis-olefin (OF), said ionomers (I_{X}) or their precursors (Iₚ) typically comprise recurring units derived from the said at least one bis-olefin (OF) in an amount comprised between 0.01% and 1.0% by moles, preferably between 0.03% and 0.5% by moles, more preferably between 0.05% and 0.2% by moles, based on the total moles of recurring units of ionomers (I_{X}) or their precursors (I_{P}), as the case may be.

The amount of said ionisable or hydrolysable groups in ionomers (I_{X}) or in their precursors (I_{P}), as the case may be, are such to provide for an overall amount of ionisable or hydrolysable groups of at least 0.55, preferably at least 0.65, more preferably at least 0.75 meq/g, with respect to the total weight of ionomers (I_{X}) or precursors (I_{P}), as the case may be.

There's no substantial limitation as per the maximum amount of the said ionisable or hydrolysable groups comprised in ionomers (I_{X}) or in precursors (Iₚ). It is generally understood that the said ionisable or hydrolysable groups are generally present in an amount of at most 3.50 meq/g, preferably at most 3.20 meq/g, more preferably at most 2.50 meq/g, with respect to the total weight of ionomers (I_{X}) or precursors (I_{P}), as the case may be.

In Step (1) of the method of the invention, an as-polymerized aqueous latex comprising particles of precursor (Iₚ) is provided.

The expression “as-polymerized aqueous latex” is hereby given its common meaning in this field, and designate aqueous dispersions comprising stably dispersed particles of polymer as obtained from emulsion polymerization. The peculiar emulsion polymerization technique used for manufacturing the said latex is not particularly limited. Techniques whereas the said latex is manufactured by emulsion polymerization in an aqueous medium in the presence of one or more than one emulsifiers, as well as techniques whereas no emulsifier as used, may be equally effective.

Non-limiting examples of emulsifiers, in particular fluorinated emulsifiers, for use in emulsion polymerization in an aqueous polymerization medium for the manufacture of latex (Iₚ), and which may be comprised in the said latex (Iₚ), include, notably, the followings:

(a′) CF₃(CF₂)ₙ₀COOM′, wherein no is an integer ranging from 4 to 10, preferably from 5 to 7, preferably no being equal to 6, and M′ represents NH₄, Na, Li or K, preferably NH₄;

(b′) [R₁—Oₙ-L-A⁻]Y⁺

wherein: R₁ is a linear or branched partially or fully fluorinated aliphatic group which may contain ether linkages; n is an integer; L is a linear or branched alkylene group which may be nonfluorinated, partially fluorinated or fully fluorinated and which may contain ether linkages; A⁻ is an anionic group selected from the group consisting of carboxylate, sulfonate, sulfonamide anion, and phosphonate; and Y⁺ is hydrogen, ammonium or alkali metal cation; amon class (b′) mention can be specifically made of:

(b′-1) T-(C₃F₆O)ₙ₁(CFYO)ₘ₁CF₂COOM″, wherein T represents a Cl atom or a perfluoroalkoxyde group of formula CₓF_{2x+1-x′}Cl_{x′}O, wherein x is an integer ranging from 1 to 3 and x′ is 0 or 1, n₁ is an integer ranging from 1 to 6, m₁ is 0 or an integer ranging from 1 to 6, M″ represents NH₄, Na, Li or K and Y represents F or —CF₃;

(b′-2) R_{f}—(OCF₂CF₂)ₖ₋₁—O—CF₂—COOXₐ (IA)

wherein R_{f} is a C₁-C₃ perfluoroalkyl group comprising, optionally, one or more ether oxygen atoms, k is 2 or 3 and Xₐ is selected from a monovalent metal and an ammonium group of formula NR^{N}₄, wherein R^{N}, equal or different at each occurrence, is a hydrogen atom or a C₁-C₃ alkyl group (b′-3) F—(CF₂CF₂)ₙ₂—CH₂—CH₂—X*O₃M′″, wherein X* is a phosphorus or a sulphur atom, preferably X* being a sulphur atom, M′″ represents NH₄, Na, Li or K and n₂ is an integer ranging from 2 to 5, preferably n₂ being equal to 3;

(c′) A-R_{bf}—B bifunctional fluorinated surfactants, wherein A and B, equal to or different from each other, have formula —(O)ₚCFY″—COOM*, wherein M* represents NH₄, Na, Li or K, preferably M* representing NH₄, Y″ is F or —CF₃ and p is 0 or 1, and R_{bf} is a divalent (per)fluoroalkyl chain or (per)fluoropolyether chain such that the number average molecular weight of A-R_{bf}—B is in the range of from 300 to 1800;

(d′) cyclic fluorocompound of formula (II):

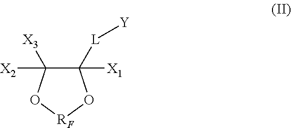

wherein X₁, X₂ and X₃, equal to or different from each other, are independently selected from the group consisting of H, F and C₁-C₆ (per)fluoroalkyl groups, optionally comprising one or more catenary or non-catenary oxygen atoms, L is a bond or a divalent group, R_{F} is a divalent fluorinated C₁-C₃ bridging group, and Y is an anionic functionality; and

(e′) mixtures thereof

The said latex is an aqueous latex, that is to say that the liquid medium whereas particles of precursor (Iₚ) are dispersed is an aqueous medium, that is to say a medium consisting predominantly of water; minor amounts of other solvents, and/or ingredients/adjuvants used in polymerizations (residues of initiators, chain transfer agents, stabilizers, emulsifiers . . . ) may nevertheless be present in the said latex.

In Step (2), the latex (Iₚ) is contacted with a basic hydrolysing agent [agent (B)], in conditions such as to at least partially convert said groups —SO₂X_{X}, —PO₂X_{X} and —COXₓ, whereas Xₓ is F or Cl, into corresponding groups —SO₃Xₐ, —PO₃Xₐ and —COOXₐ, whereas Xₐ is H, an ammonium group or a metal, preferably a monovalent metal, without causing any significant coagulation, so as to obtain an aqueous latex of particles of ionomer (I_{X}).

The choice of the said basic hydrolysing agent is not particularly limited, provided that the same can effectively cause the expected hydrolysis reaction.

Generally, an inorganic base, in particular an inorganic hydroxide of an alkali or alkali earth metal can be used, although organic bases may also be effective to this aim. Among inorganic bases which have been found useful, mention can be made of KOH, NaOH, LiOH, Mg(OH)₂, Ca(OH)₂.

Generally, the said agent (B) is used in excess with respect to the overall amount of equivalents of groups to be hydrolysed.

Temperature and stirring in Step (2) are notably controlled, in combination with the overall concentration of agent (B) so as to prevent any significant coagulation of the original latex (Iₚ) and resulting latex (I_{X}).

It is nevertheless understood that minor formation of coagulum and/or deposits may occur: situations where in Step (2) the coagulation leads to the formation of coagulum and/or deposits in an amount of less than 5% wt of the total solids content of the original latex (Iₚ) or of resulting latex (I_{X}) qualify as embodiment's whereas any significant coagulum has formed.

During Step (2), advantageously, the average particle size of the particles of precursor (Iₚ) dispersed in said original latex (Iₚ) is not significantly modified, so that it can be said that advantageously, the average particle size of the particles of ionomer (Iₓ) dispersed in said resulting latex (I_{X}) is essentially the same as the one of particles of precursor (Iₚ) dispersed in said original latex (Iₚ).

In general, average particle size of particles of precursor (Iₚ) dispersed in said original latex (Iₚ) is advantageously in the range of 15 to 150 nm; more particularly, the said average particle size is of advantageously at least 30 nm, preferably at least 50 nm, and/or of advantageously at most 140 nm, preferably at most 120 nm, most preferably at most 100 nm.

Similarly, average particle size of particles of ionomer (I_{X}) dispersed in said resulting latex (I_{X}) is advantageously in the range of 15 to 150 nm; more particularly, the said average particle size is of advantageously at least 30 nm, preferably at least 50 nm, and/or of advantageously at most 140 nm, preferably at most 120 nm, most preferably at most 100 nm.

The average primary particle size of particles dispersed in the latex (Iₚ) and/or latex (I_{X}) can be notably measured by photon correlation spectroscopy (PCS) (method also referred to as dynamic laser light scattering (DLLS) technique) according to the method described in B. Chu “Laser light scattering” Academic Press, New York (1974), following ISO 13321 Standard.

It is well-known to the skilled in the art that the PCS gives an estimation of the average hydrodynamic diameter. To the purpose of this invention, the term “average particle size” is to be intended in its broadest meaning connected with the determination of the hydrodynamic diameter. It should be also understood that, following the purposes of ISO 13321 Standard, the term “average particle size” of primary particles is intended to denote the harmonic intensity-averaged particle diameter X_{PCS}, as determined by equation (C.10) of annex C of ISO 13321.

As an example, the average primary particle size can be measured by using a Malvern Zetasizer 3000 HS equipment at 900 scattering angle, using a 10 mV He—Ne laser source and a PCS software (Malvern 1.34 version). Average particle size is preferably measured on latex specimens, suitably diluted with bidistilled water and filtered at 0.2 μm on Millipore filter.

Step (2) may further comprise, after effecting contact between agent (B) and latex (I_{P}), contacting the resulting latex (I_{X}) with at least one neutralizing agent [agent (N)], different from the agent (B). The choice of agent (N) is not particularly limited; generally, this step of contacting with an agent (N) is effective in restoring the ionisable groups of the latex (I_{X}) in their acidic form, i.e. in their —SO₃H, —PO₃H and —COOH, as the case may be. Agents (N) which have found utility include organic and inorganic acids.

Hence, the result of Step (2) of the method of the invention is a latex (I_{X}), which may comprise residues of agent (B) and/or other contaminants. The expression “contaminant” is hereby understood to encompass whichever spurious ingredient/compounds other than ionomer (I_{X}), which may be dissolved/contained in the aqueous medium of latex (I_{X}). Exemplary embodiment's of these ingredients/compounds may be residues derived from polymerization initiators, suspending agents, emulsifiers, buffering agents and other adjuvant which may have been used for manufacturing latex (Iₚ), which actually are known to be present as ionised/ionisable species in the latex (I_{X}).

According to certain embodiment's, it may be hence appropriate for the method of the invention to comprise a Step (3) of contacting said latex (I_{X}) with at least one ion exchange resin, so as to at least partially remove said residues of agent (B) and/or other contaminants.

In the rest of the text, the expression “ion-exchange resin” is understood, for the purposes of the present invention, both in the plural and the singular and is intended to denote a solid insoluble matrix (or support structure), normally in the form of beads of reduced size (e.g. from 0.1 to 5 mm), generally fabricated from an organic polymer substrate, on the surface of which are active sites (ion-exchange sites) which easily trap and release (i.e. exchange) ions in a process called ion exchange.

The ion-exchange generally undergoes no structural change in the Step (3) of ion exchange.

An ion exchange resin can be a natural or synthetic substance which can exchange its own ions with the ions present in a liquid which is contacted with.

Thus, during Step (3) ions are advantageously exchanged between the latex (I_{X}) and the ion exchange resin. Thus, for instance, anions derived from any emulsifier used for the manufacture of latex (Iₚ) are advantageously transferred from latex (I_{X}) to the ion-exchange resin. At the same time, anions initially bound to the ion-exchange resin are advantageously transferred to the latex (I_{X}).

The ion-exchange resin is usually composed of synthetic beads. Each bead is a polymer matrix containing ion exchange sites on the surface and within the matrix itself.

Preferably the polymer matrix of the ion-exchange resin comprises recurring units derived from styrene (so-called polystyrene matrix) or recurring units derived from a (meth)acrylic ester (so-called acrylic matrix).

The required exchange sites can be introduced after polymerization, or substituted monomers can be used. Preferably the polymer matrix is a crosslinked matrix. The crosslinking is usually achieved by adding a small proportion of divinylbenzene during polymerization. Non-crosslinked polymers are scarcely used because of their tendency to change dimensions in dependence on the ions bonded. More preferably the polymer matrix is a crosslinked polystyrene matrix.

There are multiple different types of ion exchange resin which are fabricated to selectively prefer one or several different types of ions.

Anions can only be exchanged for other anions, and cations for other cations. The ion exchange resin that is used is therefore specific for the type of contaminants/residues to be removed from the latex (I_{X}). It is also understood that the said contaminants/residues may be adsorbed on the ion-exchange resins according to mechanisms different from ion-exchange.

An anion exchange resin has positively charged ion exchange sites with anions linked thereto, and cation exchange resins have negatively charged ion exchange site with cations linked thereto. The ion exchange resin usually originates with attached ions that have low affinities for the exchange sites. As the latex (I_{X}) containing anions contacts the ion-exchange resin, the anions with the most affinity for the exchange sites generally replace those with the lowest affinities. It is important, therefore, that the ion exchange resin contain anions with a lower affinity than those which need to be exchanged. Anion exchange resins often use chloride (Cl⁻) or hydroxyl (OH⁻) ions because of their low affinities for the exchange sites.

Preferably the ion-exchange resin used in Step (3) of the method of the invention comprises at least one anion exchange resin, as above defined, so as to remove anionic contaminants/residues, as above detailed. Generally, emulsifiers used in the manufacture of latex (Iₚ) are metallic or quaternary ammonium salts of anionic, preferably fluorinated species, thus an anion exchange resin is usually considered as more appropriate for their sequestration and removal.

Non limitative examples of positively charged ion exchange sites of the anion exchange resin are depicted hereinafter:

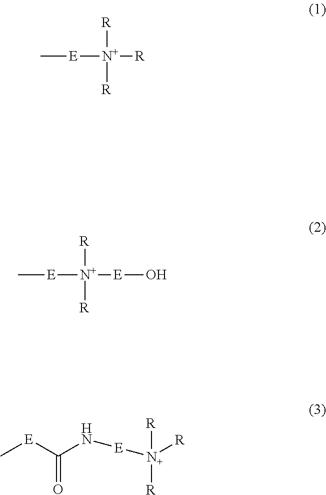

wherein, R, equal or different at each occurrence, is independently a C₁-C₁₂ hydrocarbon group or a hydrogen atom and E, equal or different at each occurrence, is independently a divalent hydrocarbon group comprising at least one carbon atom.

Preferably, the positively charged ion exchange site of the anion exchange resin are chosen among:

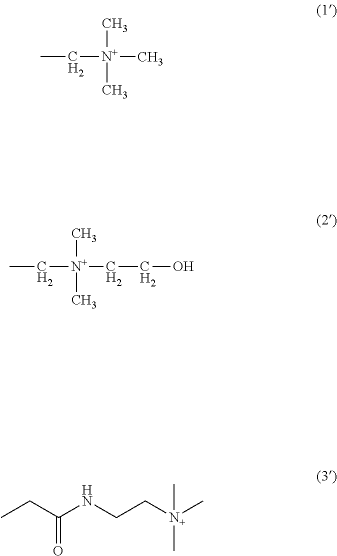

The choice of the anion bound to the positively charged ion exchange site is not critical, provided that is possesses typically less affinity to said site with respect to the anions of the contaminants/residues to be removed.

The anion ion-exchange resin has preferably linked on its positively charged ion exchange sites an anion selected among the followings: F⁻ (pKa of HF being 3.17); OH⁻ (pKa of H₂O being 15.75); CH₃O⁻ (pKa of CH₃OH being 15.5); (CH₃)₂CHO⁻ (pKa of (CH₃)₂CHOH being 16.5); (CH₃)₃CO⁻ (pKa of (CH₃)₃COH being 17).

The anion exchanger has a counterion corresponding to an acid with a pKa value of preferably at least 5, still more preferably at least 7.

Most preferred counter-ion is OH⁻.

In Step (3), once the latex (I_{X}) has been contacted with the anion exchange resin, the resin beads generally have adsorbed or bound to their positively charged ion exchange sites, the undesirable anion of the contaminants/residues and the original ion which was attached to the bead can be found in the purified latex (I_{X}).

Should the anion exchange resin comprise OH⁻ anions bound to its positively charged ion exchange sites, said OH⁻ anions are finally generally present in the purified aqueous dispersion. Therefore, the latex (I_{X}) may undergo a sensible pH increase. Depending on uses foreseen, and certainly to the aim of avoiding coagulation phenomena, a pH adjustment may be required.

Step (3) may include a step of contacting the latex (IX) with a cation exchange resin; Step (3) may include such contacting with a cation exchange resin before, after or in replacement of the contacting with the anion exchange resin. Nevertheless, to the sake of exhaustively removing residues/contaminants, and for ensuring ionisable groups to be provided in appropriate form, contacting with cation exchange resin occurs after contacting with anion exchange resin.

Non limitative examples of negatively charged ion exchange sites of cation exchange resins suitable for use in the method of the invention are depicted hereinafter:

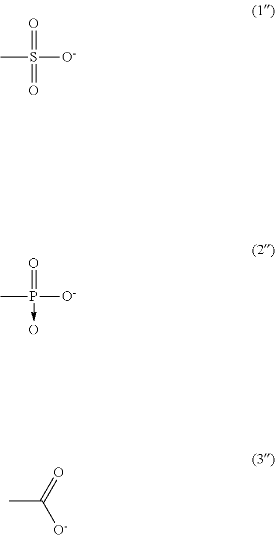

The choice of the cation bound to the negatively charged ion exchange site is not critical, provided that is possesses typically less affinity to said site with respect to the cations comprised in the latex (I_{X}) which have to be removed. For example, cation exchange resins usually come with sodium (Na⁺) or hydrogen (H⁺) ions attached to the exchange sites. Both of these ions have low affinities to the sites. Almost any cation which comes in contact with the cation exchange resin will have a greater affinity and replace the hydrogen or sodium ions at the exchange sites.

The cation exchange resin has preferably linked on its negatively charged ion exchange sites a hydrogen (H⁺) ion.

Should the cation exchange resin comprise H⁺ cations bound to its negatively charged ion exchange sites, said H⁺ cations are finally generally present in latex (I_{X}), and hence such contacting with cation exchange resins having H⁺ cations is effective in ensuring ionisable groups of ionomer (I_{X}) being in their acid form, i.e. in their —SO₃H, —PO₃H and —COOH, as the case may be.

Thus contacting the latex (I_{X}) with the cation exchange resin having hydrogen (H⁺) cation can decrease the pH of the latex (I_{X}), which may require pH adjustment by known manners.

In Step (4), the latex (I_{X}) is submitted to spray drying.

Spray drying is a well-known technique for transforming a liquid solution/suspension into a dry powder by evaporating the liquid medium from droplets dispersed in a drying chamber and contacted with a drying gas flow.

Hence, Step (4) of the method of the present invention comprises a step of passing latex (I_{X}), possibly after purification, through a nozzle for creating droplets thereof and dispersing said droplets in a drying chamber.

Any type of nozzle may be used, including notably pressure nozzles, whereas droplets size may be adjusted based on hole size and pressure; or rotary atomizers, whereas droplets size may be adjusted based on rotating element diameter and rotational speed.

As per the drying gas, in Step (4) a flow of heated air can be advantageously used, although other gases, such as notably nitrogen, can be equally effective.

The direction of the flow of the drying gas may be concurrent or counter-current with respect to the droplets flow, which is in the vertical downward direction, as effected by gravity. A combination of a concurrent and counter-current drying gas flows may be preferred for optimizing size distribution of the material (P).

In Step (4), droplets of the latex (I_{X}) are advantageously dried using a drying gas at a temperature such that the temperature in the drying chamber is of at least 50° C., preferably at least 60° C., more preferably at least 80° C., most preferably at least 85° C. For avoiding coalescence of elementary particles of latex (I_{X}), the temperature of the drying gas in Step (4) is generally adjusted such that the temperature of the drying chamber is of at most 125° C., preferably at most 120° C., more preferably at most 115° C. Ideally, a drying gas keeping a drying chamber temperature of between 90 and 110° C. will be preferred.

The result of the method of the invention is a powdery material [material (P)] composed of a plurality of particles of ionomer (I_{X}), as detailed above, which is another object of the present invention.

The material (P) of the invention is composed of particles under the form of hollow agglomerates which have an average particle size of 1 to 150 μm; preferably, average particle size of said particles is at least 3 μm, more preferably at least 5 μm and/or is of at most 100 μm, preferably at most 50 μm, even more preferably at most 40 μm.

Further, material (P) is composed of particles which are quasi-spherical.

Quasi-spherical means in accordance with the invention that the particles have a spherical or nearly a spherical shape. Geometrically, a sphere is described by axes of identical length which start from a common origin, and are directed into space and define the radius of the sphere in all spatial orientations. Spherical particles are hence particles whose shapes satisfy this geometrical requirement. On the other side, in quasi-spherical particles, the length of the axes characterizing their shape may deviate from an ideal spherical shape by from 1% to 40%. Preferably, quasi-spherical particles with deviations of up to 25% are obtained, particularly preferably up to 15%. Quasi-spherical or spherical shape of particles can be determined by image analysis of appropriate magnifications obtained by microscopy, for instance electronic microscopy.

The particles are hollow agglomerates of elementary particles. Actually, their hollow character can be proven by using scanning electron microscopy: while taking pictures of magnifications of hollow agglomerates before and after compaction with adequate pressure strength, collapse of hollow agglomerates testifying of hollow character can be easily proven.

Image analysis of microscopy magnifications shows that the said quasi-spherical particles are actually agglomerates of elementary particles corresponding to the elementary particles of the original latex (I_{X}) from which they're originating.

More particularly, the said elementary particles possess an averaged diameter of 15 to 150 nm; more particularly, the said averaged diameter is of advantageously at least 30 nm, preferably at least 50 nm, and/or of advantageously at most 140 nm, preferably at most 120 nm, most preferably at most 100 nm.

Averaged diameter of the said elementary particles can be determined by scanning electron microscopy, followed by image analysis. Sections of a magnification image are visually or computer-aided inspected and elementary particles are counted. Counted particles are modelled as spheres having as diameter the minimum diameter providing a sphere encircling the said elementary particles. Averaged diameter is hence so determined as arithmetic mean.

All the features which have been disclosed above in connection with ionomer (I_{X}) having regard to the method of the invention are also features which apply to the ionomer (I_{X}) of material (P) of the invention.

The invention further pertains to a method of providing a coating composition, said method comprising contacting the material (P) as above detailed with a liquid medium.

The choice of the liquid medium is not particularly limited; organic solvent may be used, although water-borne coating composition whereas the liquid medium comprises water, and preferably comprises water as major component are preferred. Minor amount of organic solvents, such as alcohols, in particular aliphatic alcohols (including glycols or polyols in general) can be comprised in the liquid media of water-borne coating compositions.

The coating compositions so obtained find utility for coating and/or impregnating a variety of supports.

It is hence still within the scope of the present invention a method of coating or impregnating a support, comprising using a coating composition comprising a liquid medium and material (P) as above detailed.

Should the disclosure of any patents, patent applications, and publications which are incorporated herein by reference conflict with the description of the present application to the extent that it may render a term unclear, the present description shall take precedence.

The invention will now be described in connection with the following examples, whose scope is merely illustrative and not intended to limit the scope of the invention.

### MATERIALS

### Preparative Example 1—Manufacture of TFE-VEFS Polymer Latex in —SO₂F Form

In a 22 L autoclave the following reagents were charged:
9.3 L of demineralized water;
700 g of the monomer with formula: CF₂═CF—O—CF₂CF₂—SO₂F (VEFS);
650 g of a 5 wt % aqueous solution of CIF₂O(CF₂CF(CF₃)O)ₙ(CF₂O)ₘCF₂COOK (averaged molecular weight=521, ratio n/m=10).

The autoclave, stirred at 470 rpm, was heated at 66° C. A water based solution with 9 g/L of potassium persulfate was added in a quantity of 170 ml. The pressure was maintained at a value of 14.4 bar (abs.) by feeding tetrafluoroethylene (TFE). During polymerization, aliquots of 100 g of VEFS were repeatedly added every 160 g of tetrafluoroethylene in the reactor. The reaction was stopped after 240 min by interrupting the stirring, cooling the autoclave and reducing the internal pressure by venting TFE; the total mass of TFE fed into the reactor was 3200 g. So obtained precursor latex had a solid content of 30 wt %.

A small sample of the latex thus obtained was then coagulated by freezing and thawing and the recovered polymer was washed with water and dried at 80° C. for 48 hours. The equivalent weight (EW) of the corresponding polymer was determined to be 967 g/mol through FT-IR measurement. Particles of polymer dispersed in the obtained latex were found to possess particle sizes of from 50 to 100 nm.

### Preparative Example 2—Preparation of TFE-VEFS Water-Based Dispersion

Precursor latex of Preparative Example 1 was coagulated by freezing and thawing and the recovered powder was extensively washed with water and then dried at 80° C. for 48 hours.

A portion of so obtained precursor ionomer powder (100 g) was first treated with a solution (1 L) of 14 wt % of potassium hydroxide, 30 wt % dimethyl sulfoxide and 56 wt % of demineralized water at 80° C. for 8 h under stirring. After several washings with demineralized water the solid polymer so recovered was acidified with 1 L of a 20 wt % nitric acid solution at room temperature for 2 h. The powder thus obtained was washed again with demineralized water and eventually dried in a vent oven at 80° C. for 8 h.

The quantitative conversion of —SO₂F to —SO₃H functional group was confirmed through FT-IR analysis.

Such hydrolyzed ionomer powder (60 g) was mixed with demineralized water (160 g) in a titanium 250 ml autoclave. The mixture was heated at a temperature above 180° C. and stirred at 750 rpm. After 4 h the mixture was cooled down and the water dispersion was purified by centrifugation (10,000 rpm) for 2 h. The clear and transparent dispersion of ionomer had a solid content of 22.7 wt %.

### Preparative Example 3—Hydrolysis of TFE-VEFS Precursor Latex and Provision of Ionomer Latex

One litre of precursor latex prepared in Pr. Ex. 1 was contacted with 73.5 g of NaOH/H₂O 2 wt % solution at room temperature for 5 days and then with 73.5 g of NaOH/H₂O 20 wt % for two day at room temperature. Conversion of the pristine —SO₂F group into —SO₃Na was assessed through solid state nuclear magnetic resonance (NMR). The mixture is then treated in a purification column having Lewatit Monoplus M800 OH anion exchange resin as stationary phase followed by a final treatment in a column having Lewatit Monoplus S 108 H cation exchange column as stationary phase. Complete transformation of ionisable —SO₃Na groups to —SO₃H was confirmed by ICP-OES analysis. A purified latex of ionomer in —SO₃H was hence recovered, possessing a solids content of 15% wt. Particles of ionomer dispersed in the obtained latex were found to possess particle sizes of from 50 to 100 nm.

### Comparative Example 4—Spray Drying of TFE-VEFS Dispersion from Example 2

Ionomer dispersion prepared in Preparative Example 2 (200 g), by re-dispersion in water of previously coagulated ionomer precursor, submitted to hydrolysis in solid phase, was spray dried in a spray drier device having a heated air inlet temperature of about 190° C., leading to a drying chamber averaged temperature of about 100° C. and co-current double-fluid nozzle with diameter of 0.7 mm to provide a dry powder (about 44 g).

Upon microscopy analysis, particles of the powder obtained were found to be spherical and had an average size of about 30 μm. Said particles showed no structuration as agglomerate of elementary particles: rather they were found as continuous homogeneous particles.

### Example 5—Spray Drying of Latex of Ionomer from Example 3

Ionomer latex prepared in Example 3 (200 g) was spray dried in a spray drier device having a heated air inlet temperature of about 190° C., leading to a drying chamber averaged temperature of about 100° C. and an integrated co-current double-fluid nozzle with diameter of 0.7 mm in to provide a dry powder (about 30 g).

The particles of the powder obtained were spherical and had an average size of about 10 μm; said particles were found to be hollow. Further, each particle was constituted by smaller elementary particles having averaged diameter of about 80 nm, and diameters ranging from about 60 to about 100 nm.

Re-Dispersion in Water and Viscosity Measurement of Powders from Comparative Example 4 and Example 5

Powders obtained as described in Comparative Example 4 and Example 5 were dissolved in demineralized water at room temperature and under stirring affording two water-based formulations having solid content of 25 wt %.

In both cases, the powders were easily and quickly solubilized, with no measurable solid residue. The water-based formulations were submitted to liquid viscosity measurements at room temperature (23° C.), using a viscometer with Couette geometry, with a shear rate sweep of from 100 to 1000 s⁻¹. Results are summarized in table below.

TABLE 1

| Shear Rate (s⁻¹) | Ex. 4C (Pa × s) | Ex. 5 (Pa × s) |
|---|---|---|
| 100 | 0.07 | 0.13 |
| 500 | 0.01 | 0.02 |
| 1000 | 0.007 | 0.01 |

Data summarized in Table above well demonstrate that the method of the invention provide inventive powders which are easily re-dispersible notably in an aqueous medium, and which possess ability to deliver liquid formulations possessing increased liquid viscosity in particular at low shear rate, so as to render the same compatible with typical coating techniques, without requiring the addition of thickeners or other viscosity enhancers, which may compromise, generally, the overall performances of coatings/impregnated articles obtained therefrom.

1-15. (canceled)

16. A powdery material [material (P)] composed of a plurality of particles of at least one fluorinated ionomer comprising a plurality of ionisable groups selected from the group consisting of —SO₃Xₐ, —PO₃Xₐ and —COOXₐ, wherein Xₐ is H, an ammonium group or a metal,
said particles consisting in quasi-spherical hollow agglomerates of elementary particles,
said hollow agglomerates possessing an average particle size of 1 to 150 μm; and
said elementary particles possessing an average diameter of 15 nm to 150 nm.

17. The material (P) of claim 16, wherein ionomer (I_{X}) comprises recurring units derived from ethylenically unsaturated monomer comprising at least one fluorine atom, and optionally further comprises recurring units derived from at least one hydrogenated monomer, and/or wherein ionomer (I_{X}) comprises said ionisable groups as pendant groups covalently bound to hydrolysed recurring units derived from a functional monomer (monomer (X), herein below), and optionally consists essentially of a sequence of hydrolysed recurring units derived from one or more than one monomer (X), or can be a copolymer comprising hydrolysed recurring units derived from one or more than one monomer (X) and recurring units derived from one or more than one additional monomer different from monomer (X), wherein monomer (X) is a fluorinated monomer.

18. The material (P) of claim 16, wherein ionomer (I_{X}) is an ionomer (I_{SO3X}) comprising a plurality of —SO₃Xₐ groups, and either consists essentially of a sequence of a plurality of recurring units derived from one or more than one monomer (X_{SO3X}) comprising at least one group of formula —SO₃Xₐ, wherein Xₐ is H, an ammonium group or a metal, or comprises a plurality of recurring units derived from one or more than one monomer (X_{SO3X}) and recurring units derived from one or more than one additional monomer different from monomer (X_{SO3X}).

19. The material (P) of claim 18, wherein monomer (A) is selected from the group consisting of:
sulfonyl halide fluoroolefins of formula: CF₂═CF(CF₂)ₚSO₂X_{X}, with X_{X} being a halogen, preferably, F or Cl, more preferably F, wherein p is an integer between 0 and 10;
sulfonyl halide fluorovinylethers of formula: CF₂═CF—O—(CF₂)ₘSO₂X_{X}, with X_{X} being a halogen, preferably, F or Cl, more preferably F, wherein m is an integer between 1 and 10;
sulfonyl fluoride fluoroalkoxyvinylethers of formula: CF₂═CF—(OCF₂CF(R_{F1}))_{w}—O—CF₂(CF(R_{F2}))_{y}SO₂X_{X}, with X_{X} being a halogen; wherein w is an integer between 0 and 2, R_{F1} and R_{F2}, equal or different from each other, are independently F, Cl or a C₁-C₁₀ fluoroalkyl group, optionally substituted with one or more ether oxygens, y is an integer between 0 and 6; preferably w is 1, R_{F1} is —CF₃, y is 1 and R_{F2} is F;
sulfonyl halide aromatic fluoroolefins of formula CF₂═CF—Ar—SO₂X_{X}, with X_{X} being a halogen, preferably, wherein Ar is a C₅-C₁₅ aromatic or heteroaromatic group.

20. The material (P) of claim 18, wherein monomer (B) is selected from the group consisting of:
C₂-C₈ perfluoroolefins, such as tetrafluoroethylene (TFE), hexafluoropropylene (HFP), perfluoroisobutylene;
C₂-C₈ hydrogen-containing fluoroolefins;
C₂-C₈ chloro- and/or bromo- and/or iodo-containing fluoroolefins;
fluoroalkylvinylethers of formula CF₂═CFOR_{f1}, wherein R_{f} is a C₁-C₆ fluoroalkyl, e.g. —CF₃, —C₂F₅, —C₃F₇;
fluorooxyalkylvinylethers of formula CF₂═CFOX₀, wherein X₀ is a C₁-C₁₂ fluorooxyalkyl group comprising one or more than one ethereal oxygen atom, —CF₂CF₂—O—CF₃ and —CF₃
fluorodioxoles, of formula: 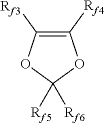
wherein each of R_{f3}, R_{f4}, R_{f5}, R_{f6}, equal or different each other, is independently a fluorine atom, a C₁-C₆ fluoro(halo)fluoroalkyl, optionally comprising one or more oxygen atom, e.g. —CF₃, —C₂F₅, —C₃F₇, —OCF₃, —OCF₂CF₂OCF₃.

21. The material (P) of claim 20, wherein at least one monomer (B) is tetrafluoroethylene (TFE) and wherein ionomer (I^{TFE}_{SO3X}) is selected from polymers consisting essentially of:
(1) recurring units derived from tetrafluoroethylene (TFE), these recurring units (1) being in an amount of 50 to 99% moles, with respect to total moles of recurring units of ionomers (I^{TFE}_{SO3X});
(2) hydrolysed recurring units comprising at least one —SO₃Xₐ group and derived from at least one monomer selected from the group consisting of:
(j) sulfonyl halide fluorovinylethers of formula: CF₂═CF—O—(CF₂)ₘSO₂X_{X}, with X_{X} being a halogen; wherein m is an integer between 1 and 10;
(jj) sulfonyl fluoride fluoroalkoxyvinylethers of formula: CF₂═CF—(OCF₂CF(R_{F1}))_{w}—O—CF₂(CF(R_{F2}))_{y}SO₂X_{X}, with X_{X} being a halogen; wherein w is an integer between 0 and 2, R_{F1} and R_{F2}, equal or different from each other, are independently F, Cl or a C₁-C₁₀ fluoroalkyl group, optionally substituted with one or more ether oxygens, y is an integer between 0 and 6; and
(jjj) mixtures thereof;
these recurring units (2) being in an amount of 1 to 50% moles, with respect to total moles of recurring units of ionomers (I^{TFE}_{SO3X}); and
(3) optionally, recurring units derived from at least one hydrogenated and/or fluorinated monomer different from TFE; these recurring units (3) being in an amount of 0 to 45% moles, with respect to total moles of recurring units of ionomers (I^{TFE}_{SO3X});
(3) from 0 to 25% moles of recurring units derived from fluorinated monomer(s) different from TFE (3), as above detailed,
based on the total moles of recurring units of said ionomers (I^{TFE}_{SO3X}).

22. The material (P) of claim 20, wherein at least one monomer (B) is vinylidene fluoride (VDF), and wherein ionomer (I^{VDF}_{SO3X}) is selected from polymers consisting essentially of:
(1) recurring units derived from vinylidene fluoride (VDF), these recurring units (1) being generally in an amount of 55 to 99% moles, with respect to total moles of recurring units of ionomers (I^{VDF}_{SO3X});
(2) hydrolysed recurring units comprising at least one —SO₃Xₐ group and derived from at least one monomer selected from the group consisting of:
(j) sulfonyl halide fluorovinylethers of formula: CF₂═CF—O—(CF₂)ₘSO₂X_{X}, with X_{X} being a halogen, wherein m is an integer between 1 and 10;
(jj) sulfonyl fluoride fluoroalkoxyvinylethers of formula: CF₂═CF—(OCF₂CF(R_{F1}))_{w}—O—CF₂(CF(R_{F2}))_{y}SO₂X_{X}
with X_{X} being a halogen, wherein w is an integer between 0 and 2, R_{F1} and R_{F2}, equal or different from each other, are independently F, Cl or a C₁-C₁₀ fluoroalkyl group, optionally substituted with one or more ether oxygens, y is an integer between 0 and 6; and
(jjj) mixtures thereof;
these recurring units (2) being in an amount of 1 to 45% moles, with respect to total moles of recurring units of ionomers (I^{VDF}_{SO3X}); and
(3) optionally, recurring units derived from at least one hydrogenated monomer or fluorinated monomer different from VDF; these recurring units (3) being in an amount of 0 to 30% moles, with respect to total moles of recurring units of ionomers (I^{VDF}_{SO3X}).

23. The material (P) of claim 16, wherein the amount of said ionisable groups in ionomers (I_{X}) is at least 0.55, and/or of at most 3.50 meq/g with respect to the total weight of ionomers (I_{X}).

24. The material (P) of claim 16, wherein said material (P) is composed of particles consisting of hollow agglomerates which have an average particle size of at least 3 μm and/or is of at most 100 μm; and/or said material (P) is composed of particles consisting in agglomerates of elementary particles possessing an averaged diameter of at least 30 nm and/or of advantageously at most 140 nm.

25. A method for making a powdery material [material (P)] composed of a plurality of particles of at least one ionisable polymer comprising a plurality of ionisable groups selected from the group consisting of —SO₃Xₐ, —PO₃Xₐ and —COOXₐ, wherein Xₐ is H, an ammonium group or a monovalent metal [ionomer (I_{X})], said method comprising:
Step (1): providing an as-polymerized aqueous latex [latex (Iₚ)] comprising particles of at least one ionomer precursor comprising a plurality of hydrolysable groups selected from the group consisting of —SO₂X_{X}, —PO₂X_{X} and —COX_{X}, wherein X_{X} is a halogen [precursor (Iₚ)]; and
Step (2): contacting said as-polymerized aqueous latex [latex (I_{X})] with a basic hydrolysing agent [agent (B)], in conditions such as to at least partially convert said groups —SO₂X_{X}, —PO₂X_{X} and —COX_{X}, wherein X_{X} is F or Cl, into corresponding groups —SO₃Xₐ, —PO₃Xₐ and —COOXₐ, wherein Xₐ is H, an ammonium group or a monovalent metal, without causing any significant coagulation, so as to obtain an aqueous latex of particles of ionomer (I_{X});
optionally, Step (3): contacting said latex (I_{X}) with at least one ion exchange resin, so as to at least partially remove residues of agent (B) and/or other contaminants; and
Step (4): spray drying the latex (I_{X}), so as to obtain the said material (P).

26. The method of claim 25, wherein material (P) is according to claim 1.

27. The method of claim 25, wherein latex (Iₚ) comprises at least one fluorinated emulsifier, selected from the group consisting of:
(a′) CF₃(CF₂)ₙ₀COOM′, wherein no is an integer ranging from 4 to 10 and M′ represents NH₄, Na, Li or K, preferably NH₄;
(b′) [R₁—Oₙ-L-A⁻]Y⁺
wherein: R₁ is a linear or branched partially or fully fluorinated aliphatic group which optionally contains ether linkages; n is an integer; L is a linear or branched alkylene group which is optionally nonfluorinated, partially fluorinated or fully fluorinated and which optionally contains ether linkages; A⁻ is an anionic group selected from the group consisting of carboxylate, sulfonate, sulfonamide anion, and phosphonate; and Y⁺ is hydrogen, ammonium or alkali metal cation;

28. The method of claim 25, wherein in Step (2), the latex (Iₚ) is contacted with a basic hydrolysing agent [agent (B)], selected from inorganic bases and/or wherein Step (2) optionally further comprises, after effecting contact between agent (B) and latex (Iₚ), contacting the resulting latex (I_{X}) with at least one neutralizing agent [agent (N)], different from the agent (B).

29. The method of claim 25, said method comprising a Step (3) of contacting said latex (I_{X}) with at least one ion exchange resin, so as to at least partially remove said residues of agent (B) and/or other contaminants; and wherein said ion-exchange resin comprises at least one anion exchange resin, wherein positively charged ion exchange sites of the said anion exchange resin are selected from the group consisting of: 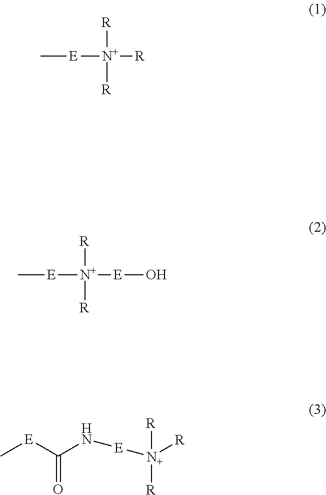
wherein, R, equal or different at each occurrence, is independently a C₁-C₁₂ hydrocarbon group or a hydrogen atom and E, equal or different at each occurrence, is independently a divalent hydrocarbon group comprising at least one carbon atom.

30. The method of claim 29, wherein Step (3) includes a step of contacting the latex (I_{X}) with a cation exchange resin before, or after contacting with anion exchange resin, and wherein negatively charged ion exchange sites of cation exchange resins are selected from the group consisting of: [chemical structure]
